(19) United States
(12) Patent Application Publication
(10) Pub. No.: US 2007/0245308 A1
(43) Pub. Date: Oct. 18, 2007

(54) Flexible XML tagging

(76) Inventors: John E. Hill, Boulder, CO (US); Justin C. Griep, Denver, CO (US); Carson W. Green, Englewood, CO (US)

Correspondence Address: HOLME ROBERTS & OWEN, LLP, 299 SOUTH MAIN, SUITE 1800, SALT LAKE CITY, UT, 84111, US

(21) Appl. No.: 11/648,362

(22) Filed: Dec. 29, 2006

Related U.S. Application Data
(60) Provisional application No. 60/755,423, filed on Dec. 31, 2005.

(51) Int. Cl. G06F 9/44

(52) U.S. Cl. 717/114; 717/104

(57) ABSTRACT

A computer implemented method for creating a customized electronic document in real time is provided. An electronic document is created from an interactive word processing application. A plurality of variables are added to the electronic document. Each variable is configured for receiving data from an input source. The variables are associated with a mark-up language. The variables are configured to be added to the electronic document in any order without disrupting the integrity of the data fields and without violating any rule of the mark-up language.

### RELATED U.S. APPLICATION DATA

This application claims priority from Provisional Application No. 60/755,423 filed on Dec. 31, 2005.

### BACKGROUND OF THE INVENTION

1. The Field of the Invention

The present invention relates generally to the creation and use of documents with stored discrete data and, in particular, to overcoming limitations with the conventional creation and use of XML tagging in a document.

2. The Relevant Technology

Document creation has advanced significantly since every document was hand written or, later, typed from scratch. In the medical field, physicians have for a long time written or dictated patient notes after seeing a patient or performing a procedure. Whether the physician handwrites the notes, types them into a computer or dictates them for later transcription, the process can be time consuming, repetitious and creates only a block of text. For example, when writing a series of patient notes for several visits of the same patient, some basic information is repeated (name, age, condition, etc.) and that information is not discrete so it is difficult to share information (like name, age, etc).

The use of forms and templates has gained wide acceptance greatly improving the efficiency of completing repetitive writing tasks and allowing the capture of discrete data. Again using the medical field as an example, doctors frequently fill out standardized super-bills which are then used to create invoices and patient records. Electronic medical records (EMR) are a relatively recent attempt to provide a standardized format for medical information mostly using discrete data entered into online forms. However, much of the work is still time consuming and better, more flexible systems are desired, particularly for clinical documentation (traditionally text based).

### BRIEF SUMMARY OF THE INVENTION

A computer implemented method for creating a customized electronic document in real time is provided. In one embodiment, an electronic document is created from an interactive word processing application. Text and a plurality of variables are then added to the electronic document. Each variable is configured for receiving, exporting or calculating data to or from an source, such as another variable, a computer keyboard, tablet pen, voice recognition software, database application, and internet information source—as examples. The variables are associated with a mark-up language, for example, extensible markup language (XML). The variables are configured to be added to and rearranged within the electronic document in any order without disrupting the integrity of the data fields, without violating any rule of the mark-up language, such as the well formed document rule associated with XML, and without violating the document schema.

In another embodiment, the computer implemented method creates a customized electronic document in real time in a word processing application stored in memory coupled to a computer having a processor so that when the application is executed by the processor, the application causes the processor to carry out the steps of the method. The method first comprises creating an electronic document from the interactive word processing application. Text and a number of variables associated with a mark-up language are selected and imported into the electronic document. A unique identifier is associated with each of the variables. A variable is selected from the plurality of variables displayed in the electronic document in the word processing application. Data is then received from an input device that is communicatively coupled to the computer and the data is associated with the selected variable. The electronic document is then stored in memory coupled to the computer. The discrete data can be operated upon, shared or acted upon. Acted upon means that the application runs operations dependent on the contained data; such as automatically displaying related data as an example.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 is a block diagram view of the networking environment for implementing several aspects of the present invention;

FIG. 2 is a block diagram of a computer device for implementing the present invention;

FIG. 3 is a drawing illustrating the relationship between FleXlates, FlexGroups, FlexFields and showing that detail information is virtualized into a separate repository;

FIG. 4 is a screen shot of a smart document showing XML tagging;

FIG. 5 is a screen shot of a Word Document Pane within ProMed Complete of a FleXlate of the present invention;

FIG. 6 is a screen shot of a view in ProMed Complete of a FleXlate of the present invention;

FIG. 7 is a screen shot of a view in a Word Document Pane of a FleXlate of a clinical SOAP note according to the present invention; and

FIG. 8 is another screen shot of the FleXlate within ProMed Complete of FIG. 7.

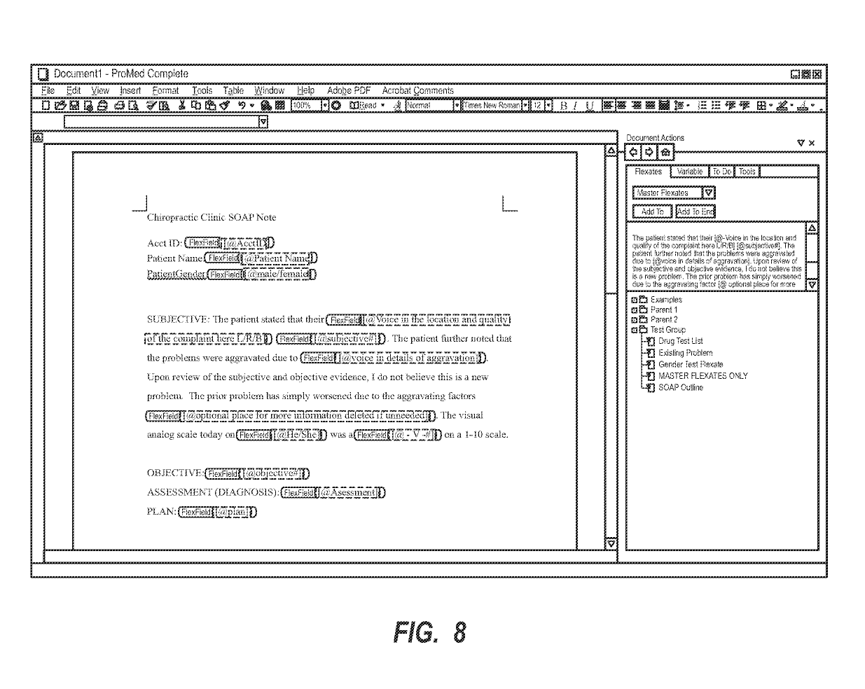

### DETAILED DESCRIPTION OF THE PREFERRED EMBODIMENTS

Patient documentation is a tedious and time-consuming task, but essential for quality patient care, communication with colleagues and support for insurance billings.

The present invention is designed to alleviate some pressures of a medical professional's life by reducing the time and hassle of completing digitally relevant chart notes, while at the same time producing professional documents that are accurate, timely and HIPAA compliant.

The power of the disclosed invention is that it overcomes a user interface problem by being dynamic and offering a full range of transcription options to meet a professional's unique style and technology preferences. It automates many traditional transcription functions, saving time and money, improving document quality, and creating digitally useful data while offering a personalized experience that reflects individual's preferences.

The user decides whether to use traditional dictation and transcription or employ advanced technology tools to speed document creation and reduce costs. For example, voice recognition technology may be used at the office, and telephone dictation when working from home; personalized templates may be used for the most common patient encounters and traditional dictation for other patient types; routine progress notes may be created in real time and more extensive notes may be sent for traditional dictation. Choosing a single method and operation is not required. Regardless of method chosen, the result is documentation with equivalent levels of digitally useful, discrete data.

In one particular embodiment, the present invention utilizes a “formless form” to capture data directly from dictation. “Formless form” documents are created in real time using a flexible template with a number of customizable variables, that may or may not be grouped together in groups containing text and variables. Real time creation of documents provides the medical professional with the ability to personalize notes, reports and letters so as to complete patient documentation almost instantly. The present invention may also be integrated with a patient scheduling system's data to provide even more productivity and cost effectiveness.

There are really only two ways that transcription companies can lower costs. The first is to outsource transcription to countries where labor costs are significantly cheaper. The second way to lower transcription costs is to use technology to replace some of the work traditionally done by transcriptionists. The present invention provides the power to decide when and how to use technology to reduce costs.

The problem with most clinical documentation software is that it requires every physician to conform to a single approach, resulting in poor adoption and an underused system. A particular group practice likely has as many different styles for documenting patient care as you have physicians. The present invention overcomes this problem by offering a full range of transcription options for every user's unique style and computer skills.

Networking Environment

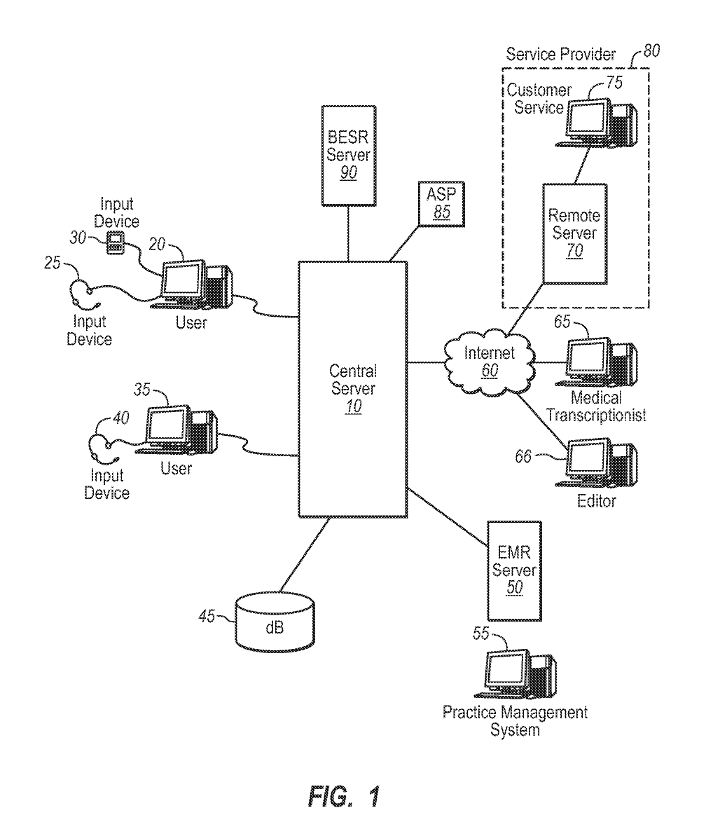

FIG. 1 illustrates the overall networking environment for implementing various aspects of the present invention. It should be appreciated by one of ordinary skill in the art that the network representation illustrated in FIG. 1 is for explanatory purposes only and should not be taken as limiting the invention in any way. At the center of the environment is a central server or platform 10. In the illustrated embodiment, server 10 is a ProMed Platform that coordinates the communication among the various entities providing data to server 10 and receiving data from the other entities. More specifically, server 10 is the central hub of a secure, web-based transcription management system that coordinates the creation, transport, workflow, delivery and archiving of transcriptions such as, for example, coordinating workflow among several physician offices, transcriptionists, insurance companies and computer systems. The environment is arranged so that the security and privacy of a patient's health information is maintained.

In the illustrated example, user computer 20 and user computer 35 are coupled to the central server 10. The user computer 20 and user computer 35 are illustrated as directly connected to the server 10, however, the connection may be made through a communication network such as a LAN, WAN, WiFi, or Internet based connection, such as a web service, to name a few. Additionally, those computers can be portable meaning that various levels of user functionality are provided regardless but dependent upon those computers being connected to the network. Computer user 20 is shown as having a first computer program resident in memory for causing its processor to perform, for example, basic transcription services. More specifically, computer user 20 is using a software application referred to as ProMed Connect, which is a document exchange system for sending, receiving and storing dictations, transcriptions, schedules and reports. Computer user 35 is illustrated as having a second computer program resident in memory for causing its processor to perform, for example, document creation services. In particular, for purposes of describing the present invention, computer user 35 is using a software application referred to as ProMed Complete, which is a document creation system for producing chart notes and other various medical documents in real time using an input device such as a speech recognition device—i.e., speech-to-text recognition software and input device—or template aided keyboard entry.

Typically, computer user 35 uses a word processing application resident in memory for creating an electronic document. In one particular embodiment, the word processing application is Microsoft Word, however, any word processing application may be used without departing from the scope and spirit of the invention. The PC of computer user 35 is communicatively coupled to an input device 40 for providing data to the electronic document created by the word processing application. Typically, input device is a speech recognition device and corresponding software such as Dragon Naturally Speaking and the Andrea NC-91 headset, but any suitable speech recognition device and software may be used. Computer user 20 may also use the speech recognition device 25, but may also use a standard digital voice recorder 30 as well. Computer users 20, 35 are coupled to the central server 10 for communicating objects such as electronic documents and discrete data to the server 10 and receiving data directly from server 10 or other devices coupled to the server 10, such as the electronic medical record (EMR) server 50 that is coupled to a practice management system 55 or database 45.

Central server 10 is also coupled to a second communication network 60, which is illustrated as the Internet. It should be appreciated that communications network 60 may also be a LAN, WAN, WiFi network as well to name a few. Since central server 10 may be coupled to an unsecure communications network 60, such as the Internet, the server 10 is therefore provided with an encryption system to protect the integrity of the sensitive documents.

In the illustrated embodiment, there are several entities that may communicate with the computer users or dictation providers 20, 35. These entities are for the purpose of creating and delivering final documentation. This documentation can be created from voice file dictations, supplied documents and data, or a combination of both.

For Example, a user 66 may receive a document from user 35 that requires editing by an editor. The user 35 transmits the document to the central server 10, either encrypted or unencrypted depending upon the requirements of the connection, which then transmits the document over communications network 60 to the editor 66. If it was not done at the user level, central server 10 encrypts the document prior to sending it over an unsecured communications network. Editor 66 receives the document, performs the edits in the document and returns the document to central server 10. The computer program resident in memory on the computer of editor 66 would encrypt the file prior to transmission.

In one instance, user 35 would receive notification from server 10 that the document has been returned from editor 65 or 66 and user 35 would then perform the necessary steps to retrieve the edited document from server 10. Server 10 may also transmit the document directly to user 35 upon receipt, for example, by web service, FTP, fax, in an email attachment or similar transmission means. User 35 may also query central server 10 for jobs that are pending, or sign off on documents returned from editor 66 and stored on server 10 or download the document and sign directly. There are any number of processes that may be put in place once server 10 has received an electronic document, and the examples listed should in no way be considered limiting.

In another example, user 20 may create an audio file for transcription that requires a medical transciptionist (MT) to transcribe. As shown, the user 20 sends the file, either encrypted or unencrypted to the central server 10. Central server 10 encrypts the file, if not already done so, and sends the file over communication network 60 to the computer of the medical transcriptionist 65. The MT 65 transcribes the file into an electronic document and sends the document back to server 10 destined for user 20. The computer of MT 65 is running a computer program that encrypts the file prior to transmission on the unsecure communication network 60. As before, user 20 may receive notification from server 10 that the document has been returned from editor 66 and user 35 would then perform the necessary steps to retrieve the edited document from server 10. Or, server 10 may transmit the document directly to user 35 upon receipt. Similar processes are available to user 20 as described with respect to user 35.

In another example, user 35 creates both an audio file and document which is securely sent through central server 10 to an editor 66. This audio file can be either a complete dictation and transcript, for example files created by using front end voice recognition technology, or can be an initial document with vocalized additions, deletions and changes. Workflow and security is as described in the previous two examples.

A service provider 80 may also be coupled to central server 10 through unsecure communication network 60. As shown, service provider 80 may have a remote server 70 and customer service computer 75 for storing and providing predefined electronic documents from the provider 80 to the server 10 for ultimate delivery and use by users 20, 35. Remote server 70 would have encryption software for encrypting the predefined electronic documents prior to transmitting them to the communications network 60 for delivery to central server 10. The predefined electronic documents may have a number of variables entered into it, thus creating a form electronic document that is easily edited by a user.

The present invention is also configured for both back end speech recognition (BESR) and front end speech recognition (FESR). The front end speech recognition typically takes place at the location of the computer of the user 20, 35. In one particular embodiment, computers 20, 35 are loaded with a speech recognition software, such as Dragon Naturally Speaking manufactured by Nuance, however, any speech recognition software may be used to perform front end speech recognition. Back end speech recognition may be provided at a BESR server 90 or at the medical transcriptionist computer 65 or editor 66. Such a configuration allows the BESR server 90, or a backend speech recognition software resident on the medical transcriptionist computer 65 or editor computer 66, to take an initial pass at transcribing a file, such as a digitally recorded file from input device 30. If the file came to the BESR server 90, the partially transcribed file from BESR would then be sent back to the central server 10 and on to the editor computer 66.

In the illustrated embodiment, an BESR ASP 85 is provided for pre-transcribing a voice file into an electronic document in accordance with aspects of the present invention. For example, discreet data may be created from the file by first converting the voice file to text and then applying natural language processing to the text. Certain things are then identified and separated and the variables of the present invention are then populated in accordance with the present invention. These methods also can apply to internal BESR processing.

It should be appreciated that the software application, comprising the document creation software described herein (as example ProMed Complete), may be resident on medical user computers 20 and 35, on medical transcriptionist/editor computer 65 and 66 and embedded in an EMR program. In this manner, all the functionality of the present invention is made available at the time of creation as well as the time of transcription or editing. So, for example, a user may create a file using input device 30, such as a digital recorder, and then send the file through central server 10 over Internet 60 to a medical transcriptionist computer 65. The transcriptionist is then able to listen to the digital file, create an electronic document and input information using the present invention and return the file to the central server for viewing by the user. And endless number of possibilities for creating electronic documents are available given the flexibility of the present invention.

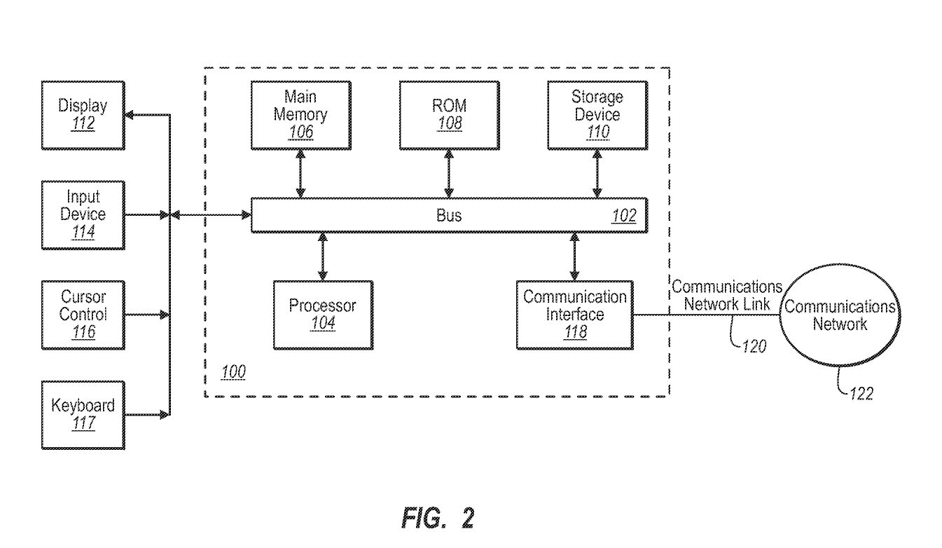

FIG. 2 is a block diagram that illustrates one embodiment of a computer system 100 for implementing several aspects of the current invention. Computer system 100 includes a bus 102 or other communication mechanism for communicating information, and a processor 104 coupled with bus 102 for processing information. Computer system 100 also comprises a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 117, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. Still another input device 114 is coupled to bus 102 for providing voice recognition input to a software program resident in main memory 106.

The invention is related to the use of computer system 100 for implementing the steps of the present invention. According to one embodiment of the invention, those techniques are implemented by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Computer system 100 also includes a communication interface 118 coupled to bus 102. Communication interface 118 provides a two-way data communication coupling to a network link 120 that is connected to a communications network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information. Network link 120 typically provides data communication through one or more communications networks to other data devices. For example, network link 120 may provide a connection through a communication network such as an Internet Service Provider (ISP), which in turn provides data communication services through the worldwide packet data communication network now commonly referred to as the Internet. Computer system 100 can send messages and receive data, including program code, through the network(s), network link 120 and communication interface 118.

Flex Technology

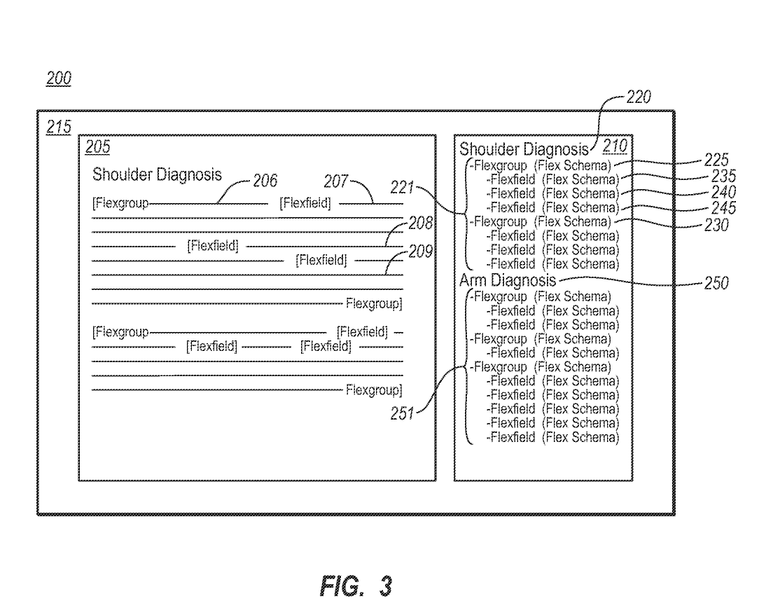

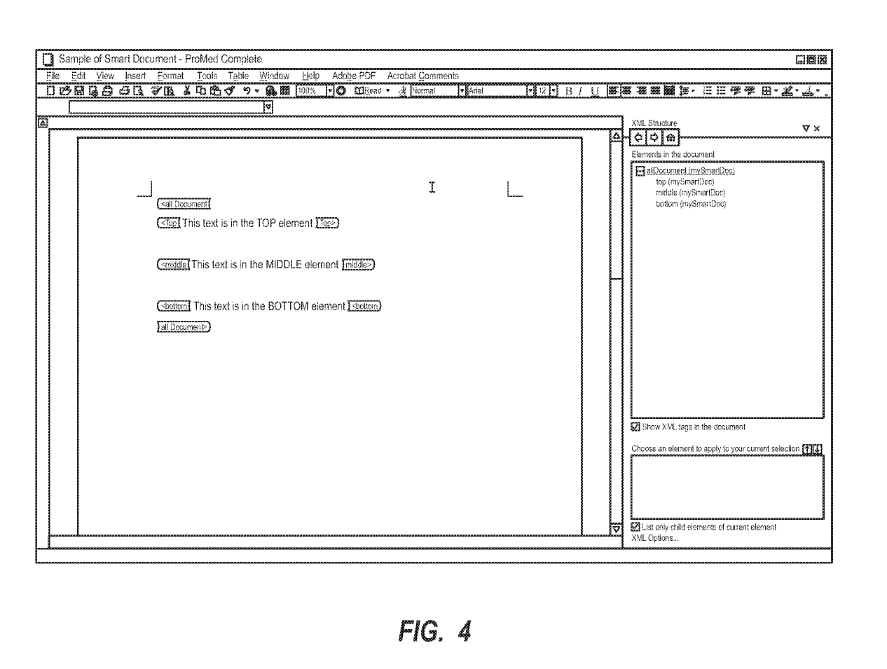

The present invention provides a flexible system (Flex Technology) to create and use documents (formless forms) in which predefined standard information is requested and input but which avoids the rigidity of conventional forms and XML tagged documents, illustrated and described with respect to FIG. 3. By way of background, FIG. 4 is an illustrative example of a screen shot of such a simple conventional XML-tagged smart electronic document. In the illustrated embodiment of FIG. 3, the word processing document is viewed in a computer software application known as ProMed Complete, which is a Word VSTO application created by the Assignee. The main window 215 is divided into a Document Pane 205 on the left side and a Task Pane 210 on the right. The document pane displays the document in various manners convenient to the user. The task pane is the currently utilized vehicle for providing the software application actions and additional information. In FIG. 3, the XML elements are shown in the Task Pane 210. The XML elements 221, 251 typically would not be illustrated in the Task Pane 210, however, they are shown for purposes of illustration and description. The document is comprised of a FleXlate, two FlexGroups and a number of FlexFields that will be described in greater detail herein.

In the illustrated embodiment of the present invention, the document consists of one to many templates called FleXlates (FLExible Xml template) mixed in with free form text. FleXlates are preformed sets of text and variables created to speed repetitive documentation. The variables in this case are special, flexible variables or fields (FlexFields) 235, 240, 245 that comprise structured data that may be used for a variety of purposes. FlexFields and text may or may not be grouped into FlexGroups. FlexFields may not contain other FlexFields so FlexGroups provide a hierarchical method of referring programmatically to groups of FlexFields and associated text as data. In the illustrated embodiment, FleXlate 1 was imported into the document pane and consists of two FlexGroups containing FlexFields and text. FlexGroup is comprised of three FlexFields 235, 240, 245.

In this embodiment, The FlexFields and FlexGroups are supported by a metadata schema for storing the name of the elements but which can contain other data such as type, action, etc. FlexFields and FlexGroups are associated to a document schema but are designed to permit additions, subtractions and movements of fields and groups while continuing to be a well formed document in XML terms and without breaking the associated schema.

In a particular application, flex-technology may be applied to the field of transcription, including medical transcription, in such a way that when a user (such as a physician) completes a document, the form nature is transparent and the building of the document is accomplished flexibly from a combination of new “free” text and predefined sections of text and variables. Documents can be created from scratch (even with variables) but for ease of use are created using FleXlates. Documents can be saved as FleXlates for reuse. Once created, FleXlates are self-contained and may be shared among users in any of a number of ways.

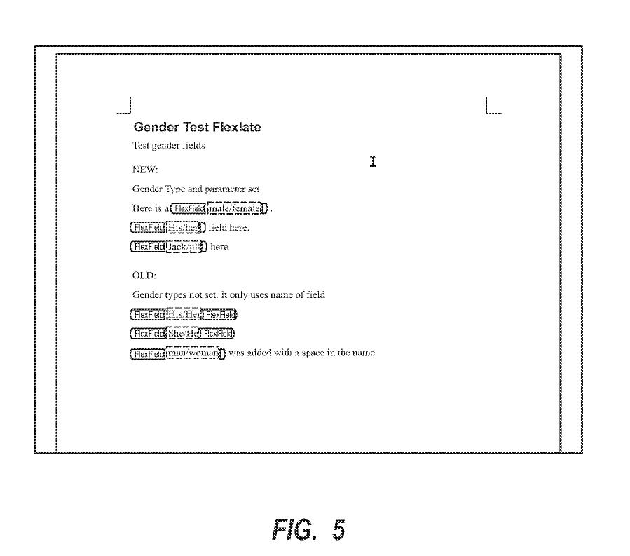

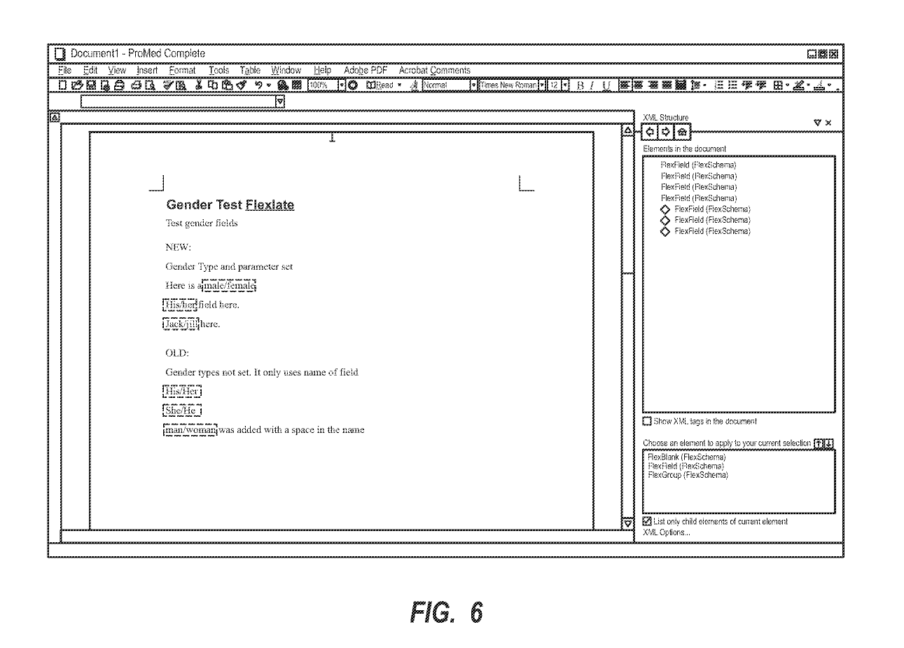

By way of further example, FIG. 5 is a screen shot of a FleXlate labeled Gender Test FleXlate in which all of the tags or variables are named FlexField at the document and schema level. The name of the tag is virtualized and stored into associated metadata. The graphic of FIG. 6 is a screen shot of the same document in FIG. 5, with the Show XML Tags function turned off such that each of the FlexFields variables are no longer visible as fields. Programmatically, a “marching ants” feature has been used to highlight the FlexFields, thereby leaving WYS/WYG formatting unaffected.

By way of further example, the Gender Test FleXlate of FIG. 5 shows three FlexFields of type=gender. When the gender of the document referenced person becomes known either programmatically from outside data or through user input, all gender variable data can be set to the proper gender. This involves storing the data, acting on data when the event of knowing gender happens (setting any one variable) and those variables can be moved around, added or deleted. When a new gender variable is added and the gender is already known, that variable will get populated on the add event.

FlexFields are defined by three properties: they can store data, they can be programmed against (program access and event driven) and they can be independent (added, removed, moved without compromising the document integrity). In this embodiment, data is stored behind using Microsoft® SmartDocument technology, the variables are programmatically accessible with events using Microsoft® SmartTag technology and the identification of individual variables is virtualized to provide flexible, hidden usage within a document (formless form).

As shown in FIG. 3, the FleXlates 220, 250 are extended Microsoft Word electronic documents that contain Flex Technology—i.e., FlexFields and FlexGroups. Currently, they are stored as XML. FleXlates are pre-built collections of text and variables used to build finished documents. In the present invention, the variables are FlexFields which are special, flexible XML tags with metadata behind them. A finished document such as a clinical note, is put together from one or more FleXlates combined with free text and data. A finished document has data filled in for one or more FlexFields. Any document can be saved as a FleXlate by stripping out the FlexField data.

To create a FleXlate, a schema is designed, similar to the schema that might be used for a conventional XML form. However, the data fields are all given the same generic name, such as FlexField. Each field is also assigned a unique identifier, such as through a unique identifier (UID) or unique name. XML metadata, indexed to the UID, is attached to the document either internally for portability or with a reference to an external source. The metadata is not displayed in the document. After the FleXlate is created, a user may move text and fields around as is possible in any word processing program to produce a custom form but without adversely affecting the schema as would occur in a conventional XML document.

Preferably, fields into which information is to be entered are flagged to aid the user, such as by underlining or highlighting them in some other fashion. The highlight may just call attention to a blank to be filled, may indicate a key word (e.g., “last name”) related to the information to be entered or may list choices for entered data. It is preferable that the highlight used not affect the format of the document nor the spacing of words and letters. After the information has been entered, the highlighting may be turned off to allow the user to clearly determine what information is still needed without being distracted by the already-entered information. Alternatively, the highlight may remain on and indicate the information that has been being entered. In such an instance, the highlight may be also turned off when the document is printed, if desired.

As stated previously, some or all of the FlexFields may be placed in groups (FlexGroups). FlexFields and FlexGroups in combination with other text are used to create a FleXlate. ProMed Complete is currently a Microsoft Office based, VSTO, Net, Visual Studios Application, allowing access to an extended Microsoft Word document. In use, ProMed Complete contains a Word document pane for the document being worked on and a task pane promoting application features. The task pane objects and methods are available for use and display in other GUIs. A user builds a document by selecting FleXlates (from the task pane), working with variables and adding free text. When selected, FleXlates appear in the document pane. FlexFields can have data entered into them or auto-fill from other data sources. The user can move easily from one field to the next. Events such as loading the FleXlate, selecting the FlexField or filling in information can trigger programmatic functions such as auto-filling data from other data sources or turning on and off FlexField identification (marching ants). Thus, when a name is entered, for example, relevant information about the person (age, address, medical condition, date of last visit, etc.) automatically fills into appropriate locations in the form. Such an action further aids the user and reduces documentation time, the amount of information which has to be entered and data entry error. The variable or FlexField is essentially a repository for data, and that data may be entered, imported, exported or calculated.

FleXlate Example

For example, in the field of medical transcription, after seeing a patient, a doctor can himself use ProMed Complete to build a clinical note from FleXlates or dictate to a transcriptionist who transcribes using FleXlates. Either way, FlexFields and FlexGroups allow discrete data to be imported into, exported out of and calculated within the document. Voice recognition may also be used to make the process more efficient for the doctor or the transcriptionist. A typical first field in the FleXlate may be for the patient name. When the name is entered, the data may cause data for other fields to be automatically imported and filled (auto-fill) from an external EMR database, such as age, gender, date of last visit, etc. Using a designated key, or using voice commands, the user may move from one FlexField to the next. If the document is being completed by a transcriptionist and the transcriptionist does not understand a word or phrase dictated by the doctor, the questionable FlexFields may be left blank or filled with what the transcriptionist believes to be the correct word or phrase. The blank and questionable FlexFields may then be highlighted for the doctor's attention. An automatic count may also be made to let the doctor know how many blank or questionable FlexFields there are for the doctor's attention. The doctor may fill in the blank fields. The questionable fields may be reviewed and the doctor may accept or reject the guess (with yes/no buttons) or may enter a correction; the highlighting will then be automatically removed without further action by the doctor. Upon completion, data (FlexFields and FlexGroups) may be automatically transmitted to the EMR database and/or converted into other documents, such as a nurse's summary, through the use of XLS transformations (XSLT).

The Document Actions view of Word is programmable with a novel interface of the present invention known as ProMed Complete. This interface, in combination with normal Word functionality, is how a Physician may quickly and easily create clinical documentation. The concept of Formless Forms along with Flex Technology allow the user to work in a flexible document format while storing discrete data behind the document. FleXlates let the user create custom documents using pre-built snippets of text and data. FlexFields allow data storage, data calculation, event driven actions and data to be imported and exported with various data sources.

A structured address represented in XML might be represented as follows:

```
<PROPERTY>
  <StreetAddress>2212 Smith Avenue</StreetAddress>
  <City>McLean</City>
  <State>VA</State>
  <PostalCode>22102</PostalCode>
</PROPERTY>
```

In the current implementation, FleXlates are pre-built combinations of text (content) and variables or FlexFields (data to be filled out, auto-inserted and/or exported). FlexFields are special virtualized XML tags with metadata attached to them. Using Flex Technology, the above structured address would look like this:

```
<FlexGroup>
  <FlexField>2212 Smith Avenue</ FlexField >
  <FlexField >McLean</ FlexField>
  <FlexField >VA</ FlexEield>
  <FlexField >22102</ FlexField>
</FlexGroup>
```

Metadata behind the document schema would record information about the FlexField instances such as name of field for example StreetAddress. By way of example, the element name is flexfield or flexgroup for all tags and the name and/or GUID of the tag is moved into metadata as follows:

```
<?xml version=“1.0” encoding=“utf-8”?>
<xs:schema id=“FlexSchema”
targetNamespace=“http://tempuri.org/FlexSchema.xsd”
elementFormDefault=“qualified”
xmlns=“http://tempuri.org/FlexSchema.xsd”
xmlns:mstns=“http://tempuri.org/FlexSchema.xsd”
xmlns:xs=“http://www.w3.org/2001/XMLSchema“
xmlns:msdata=“urn:schemas-microsoft-com:xml-msdata”>
  <xs:element name=“FlexField”>
    <xs:complexType>
      <xs:simpleContent>
        <xs:extension base=“xs:string”>
          <xs:attribute name=“UID” type=“xs:string” />
            <xs:attribute name=“Name” type=“xs:string” />
            <xs:attribute name=“Type” type=“xs:string” />
            <xs:attribute name=“Param” type=“xs:string” />
            <xs:attribute name=“IsEdited” type=“xs:boolean” />
          </xs:extension>
        </xs:simpleContent>
      </xs:complexType>
    </xs:element>
      <xs:element name=“FlexGroup”>
        <xs:complexType>
          <xs:sequence>
            <xs:any minOccurs=“0” maxOccurs=“unbounded” />
          </xs:sequence>
          <xs:attribute name=“Name” type=“xs:string” />
          <xs:attribute name=“Type” type=“xs:string” />
        </xs:complexType>
      </xs:element>
      <xs:element name=“FlexBlank”>
        <xs:complexType>
          <xs:simpleContent>
            <xs:extension base=“xs:string”>
              <xs:attribute name=“Type” type=“xs:string” />
            </xs:extension>
          </xs:simpleContent>
          </xs:complexType>
        </xs:element>
      </xs:schema>
```

Further data may be stored using this schema, additional XML or in other connected data sources such as a relational database. The resulting schema creates flexibility in the system such that elements may be added on the fly to a Word document without being required to be added to the schema. Consequently, the document adheres to the rules of a well formed document.

FlexFields should not be nested within each other because a new instance of an element may not be started before closing a prior instance of the same element in a well formed document. Therefore, the present invention provides FlexGroups to create a different flex element that can be used to encapsulate sections of the document containing FlexFields.

Flex Technology improves on Microsoft smart Documents and smart tags through the use of FlexFields and FlexGroups. Smart documents use XML to store discrete data in a document and smart tag technology allows programming against the stored data using events. Flex Technology provides flexibility and transparency for the ultimate user.

Portability

FleXlates may be shared among users in any of a number of ways. Certain basic FleXlates (Master FleXlates) may be provided freely to all users from a central repository, such as through a web services application. Other FleXlates may be developed for specific types of users, such as doctors in a particular field of practice (Practice FleXlates) and shared and exchanged among users, either through a web services application or on a more direct user-to-user basis. A user may also develop, obtain and/or customize certain favorite FleXlates that are used regularly (known as My FleXlates). Finally, other FleXlates may be provided for a fee on a licensed basis. These, too, may be made available through a web services application from a central repository. The supplier of licensed FleXlates may also provide added value by including particular features, such as internal calculations and automatic bill coding.

ProMed Complete

An example of a physician-specific application using FleXlates and Flex Technology is ProMed Complete, an application provided by the Assignee hereof. The primary use of ProMed Complete is to create a clinical note. The resulting note may be applied to another application such as an EMR, sent to an external data repository such as an EMR via HL7 or SQL, sent to ProMed Platform (a web based transcription management system), dropped into a document management system in many formats or saved as a local document and optionally printed.

As noted above, a user, such as a physician, may have three stores of prebuilt FleXlates: Master FleXlates, Practice FleXlates and My FleXlates. A physician may use a pre-built FleXlate, modify and save a pre-built FleXlate, or build a FleXlate from scratch and save it for future use.

The ProMed Complete application allows application control and data/text entry via voice, keyboard and pen based input. A clinical note may be produced by a number of different methods. The skeleton method uses a FleXlate that defines an outlined note for some particular visit type, exam or procedure. An example is a SOAP (Subjective, Objective, Assessment, Plan) note (see FIG. 6).

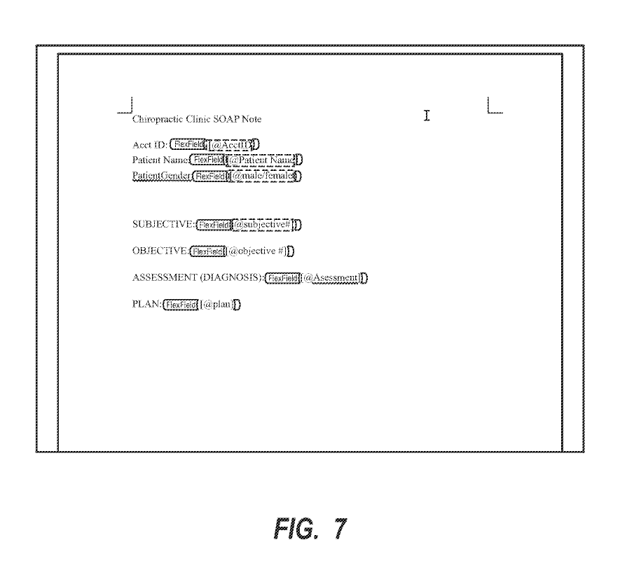

A Build method of creating a Clinical note may begin from an outline or from a blank and builds the note by including desired FleXlates according to how the visit progressed with the patient. In the Build method, several FleXlates dealing with portions of the visit are added as needed. These FleXlates contain descriptive standardized text and variables to be filled out. The user may also add free text where needed. In the example of FIG. 7, first a SOAP outline is added then a FleXlate named Existing Problem is added to the subjective part of the note.

The physician may also create a note using a Subtractive method. Here the physician pulls in a detailed note that includes common optional sections and deletes those sections which are not required or were not performed during the visit.

Use of Variables within ProMed Complete

The basic use of FleXlates allows for the flexible and automated addition of data and blocks of text. Importantly, Flex Technology allows for automating variables. These FlexFields may be of different types and may have different actions. A FlexField of type Normal is a place to store information. If the name of the FlexField is Patient Name, then the patient s name, Fred Smith, may be added to the document as discrete data. This information may then be stored elsewhere or acted upon.

By way of further example, a variable of type Gender may be set to display the male or female equivalents in nouns and pronouns such as he/she, his/her and male/female. Once the gender of a patient is known, through physician input to a field or by database (EMR) query, the entire document, put together using FleXlates, may be sexed. Also, any additional FleXlates added to the document may be added with their type gender variables set appropriately.

In the transcription world, blanks will be left in a transcription where the physician s dictation cannot be transcribed with certainty. This may be due to thick accents, a bad recording or other reasons. Conventionally, those sections have been marked with text using question marks or other special characters. Sometimes a guess at the correct words is included. It will be appreciated that many problems exist with these methods, such as the difficulty ascertaining the number of blanks in a document or having to remove special characters from a document where the guess was correct. However, using the flex technology of the present invention, a transcriptionist may add variables on the fly of type Blank. If desired, a variable may contain a guess, with formatting maintained, yet be programmatically counted and reviewed. Blanks may also be used by a self-editing provider to leave a marked space for later information.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for creating a customized electronic document in real time, said method comprising:
creating an electronic document from an interactive word processing application; and
adding a plurality of variables to said electronic document, said plurality of variables configured for receiving data, said plurality of variables associated with a mark-up language, said plurality of variables are configured to be added to said document in any order without disrupting the integrity of the data fields and without violating any rule of said mark-up language or said mark-up language schema.

2. The computer implemented method of claim 1, wherein said variables are chosen from a group consisting of text, FlexFields, FlexGroups and FleXlates.

3. The computer implemented method of claim 1, further comprising:
entering data into a first variable of said plurality of variables by performing an operation, said operation chosen from a group consisting of inputting data, importing data, exporting data or calculating data.

4. The computer implemented method of claim 3, wherein said step of entering data into said first variable is accomplished by inputting data using a speech recognition computer application.

5. The computer implemented method of claim 3, wherein said step of entering data into said first variable is accomplished inputting data using a keystroke on a computer keyboard connected to a computer having a processor and memory configured for operating a computer program for performing the steps of the computer implemented method.

6. The computer implemented method of claim 3, wherein said step of entering data into said first variable is accomplished by importing data from a central server.

7. The computer implemented method of claim 1, wherein said variables further comprise text associated with said variables.

8. The computer implemented method of claim 1, wherein said plurality of variables each have a unique identifier associated with each variable.

9. The computer implemented method of claim 1, wherein said mark-up language is extensible Markup Language (XML).

10. The computer implemented method of claim 9, wherein said plurality of variables are XML variables each having an identical identifying XML start tag and an identical identifying XML end tag.

11. The computer implemented method of claim 10, wherein said rule of said mark-up language is the well formed document rule of XML.

12. The computer implemented method of claim 1, wherein said plurality of variables are grouped together to form a group.

13. The computer implemented method of claim 1, further comprising the step of indexing metadata associated with one of said plurality of variables.

14. The computer implemented method of claim 13, further comprising the step of storing said metadata external to said electronic document.

15. The computer implemented method of claim 13, further comprising the step of storing said metadata internal to said electronic document.

16. A computer implemented method for creating a customized electronic document in real time in a word processing application, said word processing application stored in memory coupled to a computer having a processor such that when said application is executed by said processor, cause said processor to carry out the steps of said method, said method comprising:
creating an electronic document from an interactive word processing application;
inputting a plurality of variables into said electronic document, said variables associated with a mark-up language;
associating a unique identifier with each of said plurality of variables;
selecting a variable from said plurality of variables;
receiving data from an input device communicatively coupled to said computer and thereafter associating said data with said selected variable; and
storing said electronic document in memory coupled to said computer.

17. The computer implemented method of claim 16, wherein said mark-up language is extensible Markup Language (XML).

18. The computer implemented method of claim 17, wherein said plurality of variables are XML variables each having an identical identifying XML start tag and an identical identifying XML end tag.

19. The computer implemented method of claim 16, further comprising:
analyzing said data associated with said variable; and
performing an operation based upon said association between said data and said variable.

20. The computer implemented method of claim 19, wherein said operation further comprises:
retrieving information relating to said association between said variable and said data from a remote location; and
inputting said information into said electronic document.

21. The computer implemented method of claim 19, wherein said operation further comprises:
retrieving information relating to said association between said variable and said data from a remote location; and
associating said information with one or more variables of said plurality of variables.

22. The computer implemented method of claim 16, wherein said receiving data from an input device further comprises receiving a plurality of keystrokes from a computer keyboard coupled to said computer, said keystroke configured for scrolling through said plurality of variables and thereafter inputting said data into said word processing application.

23. The computer implemented method of claim 16, wherein said receiving data from an input device further comprises receiving a voice command from a voice recognition device communicatively coupled to said computer, said voice recognition device having a voice recognition computer program resident in memory on said computer, said voice recognition computer program configured for recognizing said voice commands from said voice recognition device as data and inputting said data into said word processing application.

24. A computer implemented method for creating and storing customized electronic documents in real time, said documents having medical information relating to a patient, said method comprising:
creating an electronic document from an interactive word processing application, said word processing application coupled to a first computer having memory coupled thereto;
adding a plurality of variables to said electronic document, said plurality of variables configured for receiving data, said plurality of variables associated with a mark-up language, said plurality of variables are configured to be added to said electronic document in any order without disrupting the integrity of the data fields and without violating any rule of said mark-up language;
associating a unique identifier with each of said plurality of variables;
selecting a variable from said plurality of variables;
receiving data for said selected variable from an input device communicatively coupled to said computer and associating said data with said selected variable;
transmitting said electronic document having said plurality of variables from said computer over a communication network to a central server; and
storing said electronic document in memory coupled to said central server.

25. The computer implemented method of claim 24, further comprising:
retrieving said electronic document from said central server;
transmitting said electronic document from said central server over said communication network to a second computer having memory coupled thereto.

26. The computer implemented method of claim 24, wherein said receiving data further comprises receiving data from an external input device communicatively coupled to said computer.

27. The computer implemented method of claim 26, wherein said input device is a voice recognition device.

28. The computer implemented method of claim 27, wherein said input device is an Andrea NC-91 headset.

29. The computer implemented method of claim 26, wherein said input device is a digital voice recorder.

30. A computer implemented medical transcription system for coordinating the flow of patient documentation comprising:
a first computer having a processor and a memory location, said first computer having a computer program stored in memory for performing the steps of,
creating an electronic document from an interactive word processing application, said word processing application stored in memory of said first computer,
adding a plurality of variables to said electronic document, said plurality of variables configured for receiving data, said plurality of variables associated with a mark-up language, said plurality of variables added to said electronic document in any order without disrupting the integrity of the data fields and without violating any rule of said mark-up language,
associating a unique identifier with each of said plurality of variables,
receiving data for each of said plurality of variables, and
transmitting said electronic document from said first computer to a device coupled to said first computer;
an input device communicatively coupled to said first computer, said input device configured for providing data for each of said plurality of variables to said first computer;
a communications network coupled to said first computer;
a server coupled to said communications network, said server having server memory coupled thereto, said server configured for receiving said electronic document from aid first computer, storing said document in said server memory and transmitting said document to a device coupled to said communications network; and
a second computer coupled to said communications network, said second computer having memory coupled thereto, said second computer configured for receiving the electronic document from said server memory over said communications network.

31. The computer implemented medical transcription system of claim 30, wherein said communications network is a LAN having network encryption.

32. The computer implemented medical transcription system of claim 30, wherein said communications network is the Internet and wherein said first computer, said second computer and said server are configured for document encryption.

33. A computer implemented method for creating and storing customized electronic documents in real time, said documents having medical information relating to a patient, said method comprising:
creating an electronic document from an interactive word processing application, said word processing application coupled to a first computer having memory coupled thereto;
importing a first FleXlate into said document, said first FleXlate having a plurality of FlexFields and text associated therewith, said plurality of FlexFields being configured for performing an operation, said operation chosen from a group consisting of inputting data, importing data, exporting data or calculating data, said plurality of FlexFields being associated with a mark-up language, said plurality of FlexFields being configured to be added to, deleted from or moved around within said electronic document without disrupting the integrity of the FleXlate and without violating any rule of said mark-up language or said mark-up language schema;
associating metadata with each of said plurality of FlexFields and thereafter storing said metadata in a first location within said electronic document;
selecting a FlexField from said plurality of FlexFields;
receiving data for said selected FlexField from an input device communicatively coupled to said computer and associating said data with said selected FlexField;
transmitting said electronic document having said plurality of variables from said computer over a communication network to a central server; and
storing said electronic document in memory coupled to said central server.

34. The computer implemented medical transcription system of claim 33, further comprising:
importing a second FleXlate into said electronic document, said second FleXlate having at least one FlexGroup, said FlexGroup having a plurality of FlexFields and text associated therewith, said plurality of FlexFields being configured for performing an operation, said operation chosen from a group consisting of inputting data, importing data, exporting data or calculating data, said plurality of FlexFields being associated with a mark-up language, any one of said at least one FlexGroup being configured to be moved around in said electronic document in any order without violating any rule of said mark-up language or said mark-up language schema.

35. The computer implemented method of claim 33, wherein said mark-up language is eXtensible Markup Language (XML).

36. The computer implemented method of claim 35, wherein said FlexFields are XML variables comprising:
said variables are configured to store data behind said electronic document;
said variables are configured to be acted upon programmatically and event based; and
said variables have their identity virtualized into metadata allowing movement document flexibility without breaking said schema.

37. The computer implemented method of 36, wherein Microsoft Office Smart Document technology is used to store data behind said electronic document; wherein Microsoft SmartTag technology is utilized to provide programmatic and event driven access to the variable and data; and wherein XML tags are tracked within the document, assigned a UID, and said XML tag identifier is stored separately in metadata, either internal or external to the document, so that said schema is not broken when said XML tags are deleted, added or moved.

38. The computer implemented method of claim 35, wherein said rule of said mark-up language is the well formed document rule of XML.

39. The computer implemented method of claim 33, further comprising:
using said computer implemented method within a physician facing, self-editing medical documentation system that is configured to interactively use input methods comprising speech recognition and pen tablets;
using said computer implemented method within a medical transcriptionist desktop environment so that a physician dictation can be transcribed; and
using said computer implemented method directly from an electronic medical record system (EMR).

40. The computer implemented medical documentation method of claim 39, further comprising:
securely communicating over a communication network for the purposes of,
sending voice files to a central server which can be acted upon by a medical transcriptionist at said medical transcriptionist desktop environment,
sending a document to a central server which can be acted upon by a medical editor,
sending a document and voice file to a central server which can be acted upon by a medical editor,
retrieving documents and audio files to interactively transcribe and edit medically related documents,
storing preliminary documents, audio files and finished documents,
centrally storing artifacts of the documentation process such as but not limited to flexible templates (FleXlates), collections of variables (FlexFields) and data, and
centrally collecting metrics about the usage of said medical documentation system, said metrics comprising number of documents produced, number of lines produced, keystrokes used and metrics surrounding the use of voice recognition software.
